(19) United States
(12) Patent Application Publication
(10) Pub. No.: US 2017/0058143 A1
(43) Pub. Date: Mar. 2, 2017

(54) Coated Substrates and Compositions for Coating Substrates

(71) Applicant: Landec Corporation, Menlo Park, CA (US)

(72) Inventors: Steven Bitler, Menlo Park, CA (US); Julian E. Schafer, Montara, CA (US)

(73) Assignee: Landec Corporation, Menlo Park, CA (US)

(21) Appl. No.: 15/247,944

(22) Filed: Aug. 26, 2016

Related U.S. Application Data
(60) Provisional application No. 62/211,274, filed on Aug. 28, 2015.

(51) Int. Cl. C09D 133/08; E04F 15/10

(52) U.S. Cl. CPC C09D 133/08; E04F 15/107

(57) ABSTRACT

A coated floor comprising
(1) a flooring substrate, and
(2) a solid SCC polymer coating which is adjacent to the substrate and which comprises a sidechain crystalline polymer (SCC polymer) which has now an onset of melting temperature, T₀, of at least 27° C. and a peak melting temperature (Tp) of at most 120° C.

The SCC polymer coating can be an exterior coating or can be covered by one or more exterior coatings, for example of a commercial flooring finish.

### CROSS-REFERENCE TO RELATED APPLICATIONS

This application claims priority from, and the benefit of, U.S. Provisional Application No. 62/211,274 filed Aug. 28, 2015. The entire content of that provisional application is incorporated herein by reference for all purposes. This application is also related to (1) each of the other PCT applications filed on the same day as this application and claiming priority from U.S. Provisional Application No. 62/211,274 filed Aug. 28, 2015, (2) U.S. Provisional Application No. 62/211,350, filed Aug. 28, 2015, and entitled Apparatus for Treating Coated Substrates, (3) the PCT application filed on the same day as this application and claiming priority from U.S. Provisional Application No. 62/211,350, (4) U.S. Provisional Application No. 62/211,324 filed Aug. 28, 2015, and entitled Temperature-Releasable Floor Coating System, and (5) the PCT application filed on the same day as this application and claiming priority from U.S. Provisional Application No. 62/611,324 filed Aug. 28, 2015. The entire content of each of those related applications is incorporated herein by reference for all purposes.

### BACKGROUND OF THE INVENTION

It is well known to protect and enhance the appearance of substrates, e.g. floors and countertops, by the application of a surface coating. In many cases, the coating is formed by applying to the substrate a polymeric emulsion or solution which dries to a hard protective film.

The surface coating on the floors of commercial establishments needs to be replaced at regular intervals. Many commercial floor finishes are based on acrylate polymers which are cross-linked using metal ions. The replacement of such floor coatings requires the use of alkaline strippers with consequences which are well known to be highly undesirable. Other floor coatings have better wear resistance than acrylate polymers, but must be removed mechanically, e.g. by sanding, which creates dust and which can damage the flooring substrate.

Other surface coatings which may need to be removed are (i) coatings which were originally useful but which now need to be replaced and/or removed, e.g. labels, decals, wallpaper or paint, and (ii) coatings which were never desired, e.g. graffiti.

### SUMMARY OF THE INVENTION

This invention is concerned with coatings which can be removed without using alkaline strippers. The invention makes use of compositions which (i) comprise a side chain crystalline polymer (abbreviated herein to “SCC polymer”), (ii) can be applied as a liquid to a substrate, for example a flooring substrate, and (iii) after application to the substrate, can be converted into a coating which is (a) solid, (b) is not tacky in the temperature range 15-25° C., and (c) can be triggered by heat. This composition is referred to herein as a “Releasable SCC Polymer Composition”, whether it is (i) a liquid which is ready to be applied, or has been applied, to a substrate, or (ii) a solid coating, or (iii) a solid coating which has been triggered by heat.

The term “is not tacky” is used herein to mean that the solid coating exhibits a tack value less than 25 g·cm/sec of force, measured in accordance with ASTM D2979 (see for example U.S. Pat. No. 5,387,450).

The term “can be triggered by heat” is used herein to mean that the solid coating of Releasable SCC Polymer Composition can be subjected to heating which converts the SCC polymer from a predominantly crystalline state to a partially or fully amorphous state, which enables the coating to be removed. In some cases, when the Releasable SCC Polymer Composition is triggered by heat, the SCC polymer becomes a viscous liquid or a flowing gel; in other cases, the SCC polymer softens but has little or no flow.

The term “sidechain crystalline polymer”, often abbreviated to SCC polymer or SCCP, is used to denote a polymer which contains a backbone and long side chains which (i) are attached to and extend from the backbone, and (ii) at temperatures below the melting point of the SCC polymer, can crystallize together to render the polymer predominantly crystalline.

The Releasable SCC Polymer Composition can comprise a single SCC polymer or two or more different SCC polymers. In many cases, the Releasable SCC Polymer Composition includes a matrix polymer in which the SCC polymer is dispersed.

The Releasable SCC Polymer Composition can be (i) an “exterior coating”, the term “exterior coating” being used to denote a coating which is exposed to the ambient atmosphere, or (ii) an “interior” coating, the term “interior coating” being used to denote a coating which is covered by one or more exterior coatings. The exterior coating or coatings can be composed of a conventional floor finish. The Releasable SCC Polymer Composition can be in direct contact with the substrate or can be separated from the substrate by one or more intermediate (“tie” or “primer”) coatings.

When the solid Releasable SCC Polymer Composition is triggered by heat, the SCC polymer is converted from a fully crystalline state to a partially or fully amorphous state, thus reducing the adhesion between the Releasable SCC Polymer Composition and any adjacent surface. This in turn makes it possible for at least part of the exterior coating to be removed.

It is preferred that the Releasable SCC Polymer Composition should be heated to a temperature which is greater than the onset of melting point of the SCC polymer (hereinafter abbreviated to To) and in many cases to a temperature at least as high as the peak melting temperature of the SCC polymer (hereinafter abbreviated to Tp). Particularly if the difference between the To and the Tp of the SCC polymer is large, it is preferable to heat the SCC polymer to a temperature substantially above To.

The conversion of the Releasable SCC Polymer Composition into discrete parts can be accomplished in any way. The discrete parts can be removed in any way.

Particular aspects of the present invention are summarized below.

### First Aspect of the Invention

In a first aspect this invention provides a coated floor comprising
(1) a flooring substrate, and
(2) a Releasable SCC Polymer Composition which (i) is in the form of a solid coating which is adjacent to (but not necessarily in direct contact with) the substrate (ii) is not tacky in the temperature range 15-25° C., (iii) can be triggered by heat, and (iv) comprises a sidechain crystalline polymer (SCC polymer) which has an onset of melting temperature, T₀, which is higher than any temperature to which the substrate will be exposed during normal use, and a peak melting temperature, Tp, which is less than any temperature which will damage the substrate, preferably a Tp of at most 120° C.
   In many cases, the solid coating of the Releasable SCC Polymer Composition is covered by one or more coatings of a different polymeric composition which improves the wear and/or appearance characteristics of the coated floor

### Second Aspect of the Invention

In a second aspect, this invention provides a Releasable SCC Polymer Composition which comprises (1) an SCC polymer which has an onset of melting temperature, T₀, of at least 10° C., or at least 15° C., or at least 27° C. and a peak melting temperature (Tp) of at most 120° C. and (2) a matrix polymer in which the SCC polymer is dispersed.

### BRIEF DESCRIPTION OF THE DRAWINGS

The invention is illustrated in the accompanying illustrative drawings which are diagrammatic and not to scale and in which

FIG. 1 is a cross-section through a part of a floor substrate 12 which is covered by a coating of a Releasable SCC Polymer Composition 14,

FIG. 2 is the same as FIG. 1, except that there is a coating 18 of an acrylic floor finish over the coating 14, and

FIG. 3 is the same as FIG. 2 except that there is a tie layer 20 between the substrate and the coating 14.

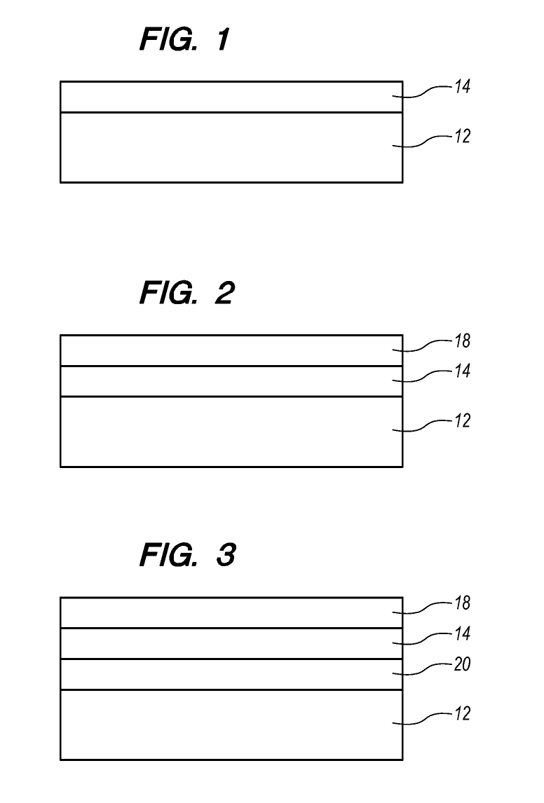

### DETAILED DESCRIPTION OF THE INVENTION

In the Summary of the Invention above and in the Detailed Description of the Invention, the Examples, and the Claims below, and in the attached drawings, reference is made to particular features (including method steps) of the invention. It is to be understood that the disclosure of the invention in this specification includes all appropriate combinations of such particular features. For example, where a particular feature is disclosed in the context of a particular aspect or embodiment of the invention, or a particular claim, that feature can also be used, to the extent appropriate, in combination with and/or in the context of other particular aspects and embodiments of the invention, and in the invention generally.

The term “comprises” and grammatical equivalents thereof are used herein to mean that other elements (i.e. components, ingredients, steps etc.) are optionally present. For example, a structure “comprising” (or “which comprises”) components A, B and C can contain only components A, B and C, or can contain not only components A, B and C but also one or more other components.

The term “consisting essentially of” and grammatical equivalents thereof is used herein to mean that other elements may be present which do not materially alter the disclosed invention.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1, and “at least 80%” means 80% or more than 80%.

The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this specification, a range is given as “(a first number) to (a second number)” or “(a first number)-(a second number)”, this means a range whose lower limit is the first number and whose upper limit is the second number. For example, “from 2 to 16” or “2-16” means a range whose lower limit is 2 and whose upper limit is 16.

The numbers given herein should be construed with the latitude appropriate to their context and expression.

The terms “a”, “an” and “the” before an item are used herein to mean that there can be a single such item or two or more such items, unless the context makes this impossible.

The term “plurality” is used herein to mean two or more.

In describing and claiming the invention below, the following abbreviations, definitions, and methods of measurement (in addition to those already given) are used.

Parts and percentages are by weight, unless otherwise noted.

Temperatures are in degrees centigrade, unless otherwise noted.

Particle sizes given herein are median particle sizes measured by a Horiba LA-910 laser light scattering analyzer.

The viscosities given herein were measured at 20° C. using a Brookfield LVF viscometer with spindle #3 at 60 RPM. The abbreviation Tₒ is used to denote the onset of melting and the abbreviation Tₚ is used to denote the peak crystalline melting point, both measured by means of a differential scanning calorimeter (DSC) at a rate of 10° C./minute and on the first heating cycle. Tₒ and Tₚ are measured in the conventional way well known to those skilled in the art. Thus Tₚ is the temperature at the peak of the DSC curve, and Tₒ is the temperature at the intersection of the baseline of the DSC peak and the onset line, the onset line being defined as the tangent to the steepest part of the DSC curve below Tₚ.

The molecular weights given herein were measured by gel permeation chromatography using a Perkin-Elmer Series 200 Autosampler and Binary LC pump with 3 Phenomenex GPC columns in two Series 200 Peltier Column Ovens followed by a Series 200a refractive index detector and ASTRA software.

The term “VCT tile” (a commercial acronym for vinyl composition tile) is used herein to denote a floor tile which is composed primarily of ground limestone, vinyl resin (typically a polymer of 95% vinyl chloride and 5% vinyl acetate) and plasticizer (typically one or more phthalate esters); ASTM F1066-04 sets out certain requirements for VCT tiles such as dimensional stability and impact and heat resistance.

The SCC Polymers Used in this Invention.

The SCC polymers used in this invention have an onset of melting temperature, T₀, which is higher than any temperature to which the substrate will be exposed during normal use, and a peak melting temperature (Tp) which is less than any temperature which will damage the substrate, preferably a Tp of at most 120° C.

In various embodiments of the invention, the SCC polymer has one or any possible combination of one or more of the following characteristics:—
(a) the SCC polymer has a To of at least 10° C., or at least 15° C., or at least 27° C., or at least 35° C., or at least 40° C.,
(b) the SCC polymer has a Tp of at most 80° C., preferably at most 60° C., particularly at most 50° C.,
(c) the SCC polymer has a Tp and a T₀, measured in degrees centigrade, such that the value of (Tₚ−T₀) is less than Tₚ^{0.7}, preferably less than 25° C., preferably less than 20° C., particularly less than 15° C.,
(d) the SCC polymer has a weight average molecular weight of at most 100,000 Da, preferably at most 50,000 Da, particularly at most 20,000 Da, and in some applications less than 10,000 Da,
(e) the SCC polymer has been prepared by an emulsion polymerization process which produces particles having a size of 0.07 to 0.5 μm, particularly 0.1 to 0.25 μm,
(f) the SCC polymer comprises units derived from one or more n-alkyl acrylates or methacrylates in proportions by weight such that the average length of the n-alkyl groups is 16-20, for example 16-18, carbon atoms, the n-alkyl groups for example containing 8-22 carbon atoms, and the polymer for example containing 90 to 98%, e.g. 94 to 97%, by weight of the units derived from one or more n-alkyl acrylates.
(g) the SCC polymer comprises 90-98%, e.g. 94-97%, by weight of units derived from octadecyl acrylate and hexadecyl acrylate, the ratio of octadecyl acrylate to hexadecyl acrylate units being for example 16 to 2.
(h) the SCC polymer contains, for example in amount greater than 1%, for example 1-4%, e.g. 2-4%, or 1-3%, or 1-2%, units derived from (i) a comonomer containing a carboxylic group, e.g. methacrylic acid, and/or (ii) a comonomer containing a hydroxyl group, e.g. hydroxyethyl acrylate, hydroxyethyl methacrylate hydroxypropyl acrylate or hydroxypropyl methacrylate.
(i) the SCC polymer has a heat of fusion of at least 20 Joules/g

The SCC polymer often also contains the residue of a chain transfer agent, e.g. n-dodecyl mercaptan or butyl mercaptopropionate or methyl benzyl alcohol, which was used during the polymerization in order to control the molecular weight of the polymer.

The monomers can be reacted together by random, stepwise or block copolymerization.

The SCC polymer preferably contains little or substantially no low molecular weight oligomers or unreacted monomers. For example, the polymer preferably contains less than 2000 ppm of unreacted monomers.

Other SCC polymers can be produced using monomers which are not acrylate or methacrylates, e.g. polymers derived from vinyl esters of fatty acids, copolymers of ethylene and/or 1-alkenes, and polymers derived from other long chain alkyl monomers, for example as described in the US patents incorporated by reference herein.

In some embodiments the SCC polymers used in this invention are produced by emulsion polymerization. The polymers prepared by emulsion polymerization preferably have a particle size of 0.07 to 0.5μ, particularly 0.1 to 0.25μ, particularly 0.1-0.15 μm. However, higher particle sizes, e.g. up to 1μ, can be used if the polymer is present in a formulation containing appropriate amounts of other ingredients to ensure film formation. The larger size SCC polymer particles may alternatively be created by mechanical emulsification of melted SCC polymers prepared by bulk or solution polymerization processes. When the SCC polymer is applied to the substrate as a solution in a solvent or is melt-applied, the particle size of the SCC polymer is less relevant.

SCC polymers are in themselves known. Publications describing SCC polymers include U.S. Pat. Nos. 4,830,855, 5,120,349, 5,156,911, 5,254,354 5,387,450, 5,412,035, 5,469,867, 5,665,822, 5,752,926, 5,783,302, 5,807,291, 5,826,584, 6,199,318 6,255,367, 6,376,032, 6,492,462, 6,540,984, 6,544,453, 6,831,116, 6,989,417, 7,101,928, 7,169,451, 7,175,632, 7,449,511, 7,182,951, 7,291,389 and 8,114,883; J. Poly. Sci. 60, 19 (1962), J. Poly. Sci, (Polymer Chemistry) 7, 3053 (1969), 9, 1835, 3349, 3351, 3367, 10, 1657, 3347, 18, 2197, 19, 1871, J. Poly. Sci, Poly-Physics Ed 18 2197 (1980), J. Poly. Sci, Macromol. Rev, 8, 117 (1974), Macromolecules 12, 94 (1979), 13, 12, 15, 18, 2141, 19, 611, JACS 75, 3326 (1953), 76; 6280, Polymer J 17, 991 (1985); and Poly. Sci USSR 21, 241 (1979). The entire disclosure of each of those United States patents and publications is incorporated in this specification by reference.

### Preparation of the SCC Polymers.

Those skilled in the art of the SCC polymers are conversant with the known methods for preparing SCC polymers. Reference may be made, for example, to the patents and publications incorporated by reference, for example U.S. Pat. No. 6,540,984 and U.S. Pat. No. 7,175,832 describing emulsion polymerization methods. Those skilled in the art, having regard to their own knowledge and the disclosure in this specification, will have no difficulty in preparing SCC polymers which are useful in this invention.

### Releasable SCC Polymer Compositions Containing Additional Ingredients.

When the SCC polymer has been produced by emulsion polymerization, it is difficult to make the SCC polymer particles coalesce, when the SCC polymer is dried at temperatures less than To, to form a continuous and crack-free coating. To avoid or limit the need to dry the SCC polymer emulsion at an elevated temperature, the Releasable SCC Polymer Composition applied to the substrate preferably contains additional ingredients which make it easier to form a thin, continuous and crack-free coating containing the SCC polymer. The additional ingredients may include, but are not limited to, non-crystalline polymers, water, solvents, diluents, wetting agents, thickeners, plasticizers and/or other additives that aid in the application, spreading and film formation of the coating.

The choice of additional ingredients preferably takes into account the physical and chemical properties of the surface of the substrate on which the Releasable SCC Polymer Composition is to be formed and the physical and chemical properties of any other coating later applied over the Releasable SCC Polymer Composition.

Preferably one of the additional ingredients which remains in the final coating is a matrix polymer in which the SCC polymer is dispersed. The matrix polymer provides film-forming properties to the Releasable SCC Polymer Composition. The matrix polymer comprises one or more polymers, each of which is at least partially amorphous, and may be substantially amorphous, and which preferably is a film-forming polymer in the absence of plasticizers or coalescing solvents. However, the matrix polymer may contain plasticizers and/or coalescing solvents to provide or enhance the film-forming properties of the matrix polymer.

In some embodiments, the matrix polymer is a styrene-acrylic polymer, or another acrylic polymer, the polymer containing 0-25%, e.g. 1-25%, or 0-20%, e.g. 1-20%, or 0-15%, e.g. 1-15%, or 0-5%, e.g. 1-5%, of units derived from one or more monomers containing carboxylic groups, for example methacrylic acid.

In some embodiments, the matrix polymer is a styrene-acrylic polymer, or another acrylic polymer, the polymer being present, in the liquid Releasable SCC Polymer Composition in the form of an emulsion. The styrene-acrylic polymer or other acrylic polymer can be a core shell styrene-acrylic polymer or another core shell acrylic polymer.

The matrix polymer can for example be (i) a polymer which is not cross-linked and which has a molecular weight of up to 100,000, or (ii) a cross-linked polymer which has a molecular weight of over 100,000 or a gel with an infinite molecular weight.

The matrix polymer can for example have (i) an average particle size of 0.05-0.2 μm, e.g. 0.05-0.10 μm and/or (ii) an acid monomer content of 0-20%, or 0.5%, e.g. 1-5% and/or (iiii) a pH of 2-10, or 5-9, or 2-6.

The matrix polymer optionally has an MFFT below 20° C. Examples of such matrix polymer include Raykote 1610 (50% NV, 7° C. MFFT), Raytech 22053 (40.9% NV, 2° C. MFFT) and Rayflex 610 (58% NV, 0° C. MFFT). The MFFT of a polymer can be measured by ASTM D2354.

In some embodiments, the Releasable SCC Polymer Composition contains (a) 10-80%, or 30-80%, or 30-60%, e.g. 50-60%, of the SCC polymer and (b) 20-70%, for example 30-60% or 40-50%, of the matrix polymer. However, the invention includes the possibility that the Releasable SCC Polymer Composition contains 1-99% of the SCC polymer.

Other additional ingredients which are optionally present in the Releasable SCC Polymer Composition include (i) water and/or other ingredients, e.g. solvents, which evaporate after the composition has been applied to, and dried on, the substrate, and which are not, therefore, present in the final coating, and (ii) one or more other ingredients which remain in the final coating. The additional ingredients can include (i) thickeners, to decrease the tendency of a low solids coating to crawl and retract from the edges of the substrate due to poor wetting, for example in amount 0.1-0.2% solids on the total formulation, e.g. Acrysol TT-935, Acrysol TT-615 and the other hydrophobically-modified alkali swellable emulsions, (ii) surface tension reducers, for example in amount 0.05-0.4% or 0.1-0.4% solids on the total formulation, e.g. Fluorad FC-4432, Fluorad FC-129, Capstone FS-60 and Zonyl FSO, (iii) wetting and anti-foaming agents, for example in amount 0.05-0.25% solids on the total formulation, e.g. Surfynol 104A, Surfynol 104PA and Surfynol 485W, (iv) water-soluble solvents to improve film spreading, substrate wetting and interfacial adhesion, for example in amount 1-5% of the composition as it is applied to the substrate, e.g. glycol ethers and alcohols, and (v) plasticizers or coalescent agents to improved film formation during drying at ambient temperature.

Thus, the composition, when it is ready to be applied to the substrate, preferably contains other ingredients including, but not limited to, one or more matrix polymers, water, one or more surfactants, and one or more cosolvents. The composition can also contain additional ingredients which remain in the solid coating of the Releasable SCC Polymer Coating, and which improve the compatibility between (i) the coating and the substrate to which the liquid Releasable SCC Polymer Composition is applied and/or (ii) an exterior coating which is applied on top of the Releasable SCC Polymer Composition.

In particular embodiments of the invention, the Releasable SCC Polymer Composition comprises a matrix polymer having one or any possible combination of two or more of the following optional characteristics:—.
(a) the matrix polymer has a minimum film forming temperature (MFFT) which is at most 20° C.,
(b) the matrix polymer has a minimum film forming temperature (MFFT) which is at least 20° C.
(c) the matrix polymer is miscible with water,
(d) or styrene-acrylic polymer prepared by emulsion polymerization, for example a cross-linked styrene-ethylhexylacrylate-methacrylic acid polymer, a styrene-butylacrylate-methacrylic acid polymer, a styrene-butylacrylate-methylmethacrylate-methacrylic acid polymer, or an isobutyl methacrylate-methylmethacrylate-hydroxyethyl acrylate polymer,
(e) the matrix polymer is composed of particles which are smaller than the particles of the SCC polymer, and
(f) the matrix polymer forms a continuous phase in which the SCC polymer is dispersed in the form of particles.

### Additional Details of the Releasable SCC Polymer Composition and Other Coatings.

In some embodiments of the invention, the Releasable SCC Polymer Composition is in the form of a solid coating which has a thickness of less than 10 μm, preferably less than 5 μm, or less than 2 μm, e.g. less than 1 μm. There can be two or more solid coatings each of which is a Releasable SCC Polymer Composition. When there are two or more such coatings, they are preferably applied separately and optionally can be separated by one or more polymeric coatings which are not composed of a Releasable SCC Polymer Composition, for example a polymeric coating which is not a Releasable SCC Polymer Composition, for example does not contain an SCC polymer, or a polymeric composition suitable for use as a wear coating as described below.

In some embodiments of the invention, the solid coating of the Releasable SCC Polymer Composition directly contacts the flooring substrate. In other embodiments, it is separated from the flooring substrate by an intermediate (“tie” or “primer”) layer, for example an intermediate layer comprising a polymeric composition which is not a Releasable SCC Polymer Composition and which optionally does not include an SCC polymer. The tie layer can make it easier to form a coating of the Releasable SCC Polymer Composition on the substrate and/or to subsequently remove part or all of a solid coating of the Releasable SCC Polymer Coating.

Particularly if the surface of the substrate has a porous, matte or otherwise non-uniform and non-glossy surface, there is preferably a tie layer which is between the substrate and the solid coating of the Releasable SCC Polymer Composition. This can makes it easier to form a uniform coating of the Releasable SCC Polymer Composition, and/or can reduce the number of outer coats which need to be applied over the solid coating of the Releasable SCC Polymer Composition in order to achieve a satisfactory appearance. Preferably the tie layer has sufficient abrasion resistance to ensure that it remains in place after the Releasable SCC Polymer Composition has been removed. Polyurethane compositions have been found to be particularly useful as tie or base coats.

Exemplary tie layers include traditional floor finishes, including crosslinked and non-crosslinked coatings such as acrylic polymer (including uv-cured acrylic polymer), polyurethane (including uv-cured polyurethane and polyurethane that is not uv-cured), polyurea, epoxy polymer (including uv-cured epoxy polymer), polysiloxane, vinyl polymer, styrene-butadiene polymer, as well as factory-applied coatings, concrete treatments, penetrating sealers, densifiers and other suitable coatings and treatments known to those skilled in the art. A tie layer may have a dry weight coating thickness of about 0.01 mil to about 100 mil.

In many embodiments of the invention, there is an exterior coating on top of the solid coating of the Releasable SCC Polymer Composition, for example an exterior coating which comprises one or more coatings of a commercially available flooring finish. The wear coating can for example be a coating formed from a coating composition as disclosed in U.S. Pat. No. 5,977,228 (Mauer), International Publication WO 1999/000459 or International Publication WO 2012/162641. The entire content of each of those publications is incorporated herein by reference for all purposes.

When there is more than one coating on the substrate, the coatings may have the same or different compositions.

The Substrates Used in this Invention.

The substrate which carries the Releasable SCC Polymer Composition can be of any kind, but the invention is particularly useful when the substrate is a fixed floor surface or a substrate, for example a VCT tile or linoleum, which can be secured to a fixed substrate to provide a fixed floor surface.

In one embodiment of the invention, the substrate is a vinyl composition tile (VCT). Such tiles are well known and are composed primarily of ground limestone, vinyl resin (typically a polymer of 95% vinyl chloride and 5% vinyl acetate) and plasticizer (typically one or more phthalate esters); ASTM F1066-04 sets out certain requirements for VCTs such as dimensional stability and impact and heat resistance.

VCTs are frequently supplied with an upper surface coating of a thin (about 0.2 mil thick) acrylic lacquer sealer. Often, after the tiles have been secured to the rigid substrate, they are given three or four coatings of a conventional acrylic VCT finish, in order to produce a desirable glossy and wear-resistant surface.

The Releasable SCC Polymer Composition can be formed directly on a VCT, whether or not the VCT has a surface coating of an acrylic lacquer sealer. After the Releasable SCC Polymer Composition has been formed, one or more coats, e.g. 3-6 coats, of a conventional floor finish can optionally be applied so that the finished floor has desired durability and appearance.

### EXAMPLES

The invention is illustrated by the following Examples.

### Example 1

This example shows the preparation of SCC polymers suitable for use in this invention. Table 1 below sets out the monomers which were used to prepare Polymers 390-18, 390-28, 390-38, 390-44, 390-58, 390-78 and 390-100. Table 2 below sets out the properties of the prepared polymers.

TABLE 1

| | Polymer | Polymer | Polymer | Polymer | Polymer | Polymer | Polymer |
|---|---|---|---|---|---|---|---|
| | 390- | 390- | 390- | 390- | 390- | 390- | 390- |
| Monomer Mixture A | 18 | 28 | 38 | 44 | 58 | 78 | 100 |
| octadecyl acrylate | 324 | 482 | 500 | 492 | 379 | 478 | 399 |
| hexadecyl acrylate | 216 | 58 | 34 | 34 | 162 | 68 | 171 |
| methacrylic acid | 16.9 | 17.0 | 17.0 | 14.2 | | 14.1 | |
| n-dodecyl Mercaptan | | 5.7 | 11.4 | 22.8 | 22.8 | 2.3 | |
| butyl | 5.7 | | | | | | 1.0 |
| mercaptopropionate | | | | | | | |
| Totals, gr | 562.6 | 562.7 | 562.4 | 563.0 | 563.8 | 562.4 | 571.0 |

The polymers shown in Table 1 were prepared by delayed feed free-radical initiated redox polymerization of monomer emulsions to produce variations in molecular weight, acid functionality and melt transition temperature. The monomers were melted and blended at 45-50° C. with a mercaptan chain transfer agent. The resulting mixture was then emulsified into an aqueous surfactant mixture B containing:

| | | |
|---|---|---|
| 285.2 | g | deionized water |
| 63.0 | g | n-propanol |
| 12.0 | g | ethoxylated C10-C12 alcohol sulfosuccinate |
| | | disodium salt, 31% |
| 5.7 | g | ethoxylated C16-C18 alcohol |
| 4.1 | g | ethoxylated C12-C14 secondary alcohol |
| 0.2 | g | t-butyl hydroperoxide, 70% in water |

The resulting monomer emulsion, kept warm at 38-42° C. in a jacketed glass feeding tank, was pumped to a stirred reactor at 63-65° C. containing:

| | | |
|---|---|---|
| 320.1 | g | deionized water |
| 0.03 | g | hydroxyethyl EDTA, ferric complex |
| 63.1 | g | n-propanol |
| 13.5 | g | ethoxylated C10-C12 alcohol sulfosuccinate |
| | | disodium salt, 31% |
| 4.5 | g | sodium alpha C12-14 olefin sulfonate, 35% |
| 0.6 | g | ethoxylated C12-C14 secondary alcohol |
| 30.0 | g | styrene-acrylic seed polymer, 0.05-0.06 micron □ |

simultaneously with a delayed feed of activator solution:

| | | |
|---|---|---|
| 0.45 | g | hydroxymethane sulfinic acid, sodium salt |
| 24.7 | g | deionized water |
| 4.8 | g | n-propanol |

while maintaining reactor contents at 63-65° C. for two hours until all feeds were completed.

The following initiator and activator solutions were pumped into the reactor over 80 minutes at 62-63° C. in order to reduce un-reacted monomer levels:

### Initiator:

| | |
|---|---|
| 0.38 g | t-butyl hydroperoxide |
| 1.08 g | ethoxylated C12-C14 secondary alcohol |
| 1.25 g | water |

### Activator:

| | | |
|---|---|---|
| 0.60 | g | hydroxymethane sulfinic acid, sodium salt |
| 19.5 | g | water |

After feeds were completed and contents cooled to 38° C., pH was adjusted to 7.3 with 25% aqueous ammonia. After cooling to room temperature, the product was filtered through 200 mesh screen yielding about 1.3 kg of emulsion.

TABLE 2

| | Polymer | Polymer | Polymer | Polymer | Polymer | Polymer | Polymer |
|---|---|---|---|---|---|---|---|
| | 390- | 390- | 390- | 390- | 390- | 390- | 390- |
| Finished Properties | 18 | 28 | 38 | 44 | 58 | 78 | 100 |
| Net yield, gr | 1280 | 1323 | 1343 | 1356 | 1364 | 1385 | 1348 |
| Viscosity, cP | 35 | 510 | 72 | 184 | 80 | 36 | 74 |
| NV solids, % | 45.6 | 42.9 | 43.4 | 43.6 | 43.4 | 43.2 | 44.3 |
| pH | 6.5 | 7.0 | 7.1 | 7.3 | 6.3 | 7.2 | 7.0 |
| Median particle | 950 | 126 | 110 | 122 | 105 | 129 | 158 |
| size, nm | | | | | | | |
| Tp @10° C./min | 39.72 | 45.62 | 45.76 | 45.29 | 42.75 | 45.88 | 44.55 |
| To @10° C./min | 34.74 | 42.24 | 42.88 | 42.23 | 39.85 | 42.49 | 42.16 |
| Tp − To | 5.02 | 3.38 | 2.88 | 3.06 | 2.90 | 3.30 | 2.39 |
| Mw, daltons | 22,547 | 30,965 | 19,789 | 7,738 | 7,049 | 87,346 | 179,251 |
| Mn, daltons | 4,067 | 6,866 | 2,998 | 3,783 | 3,598 | 12,437 | 3,890 |
| Polydispersity | 5.5 | 4.5 | 6.6 | 2.0 | 2.0 | 7.0 | 46.1 |

### Example 2

This example shows the conversion of SCC polymers 390-38 and 390-44 into SCC polymer compositions suitable for coating on a substrate, using a stepwise blending procedure to incorporate the less compatible ingredients with the polymer emulsions. In the first step, a polymer mixture was prepared from the ingredients shown in Table 3 below. In the second step, the resulting polymer mixture was blended with the diluent mixture shown in Table 4, to produce an SCC polymer composition having the physical properties show in Table 4.

TABLE 3

| Polymer mixture | 390- | 390- | 390- | 390- | 390- |
|---|---|---|---|---|---|
| (in grams) | 63A | 63B | 65A | 65C | 75A |
| SCC polymer 390-44 | 3.70 | | 3.94 | 3.70 | 3.28 |
| (43.6% NV) | | | | | |
| SCC polymer 390-38 | | 3.71 | | | |
| (43.4% NV) | | | | | |
| Deionized water | 20.00 | 20.01 | 20.21 | 20.41 | 22.53 |
| Matrix polymer: | | | | | |
| Raykote 1610 (50.0% | 2.20 | 2.20 | | | |
| NV, 7° C. MFFT) | | | | | |
| Raytech 22053 (40.9% | | | 2.39 | | |
| NV, 2° C. MFFT) | | | | | |
| Rayflex 610 (58.0% | | | | 1.90 | 1.87 |
| NV, 0° C. MFFT) | | | | | |
| Thickener: | | | | | |
| Acrysol TT-935 | 0.70 | 0.53 | | 0.41 | 0.33 |
| Acrysol TT-615 | | | 0.54 | | |
| Sub-totals | 26.60 | 26.45 | 26.56 | 26.42 | 28.01 |

TABLE 4

| Diluent mixture | 390- | 390- | 390- | 390- | 390- |
|---|---|---|---|---|---|
| (in grams) | 63A | 63B | 65A | 65C | 75A |
| Fluroad FC-4432 | 0.20 | 0.20 | 0.21 | 0.16 | 0.17 |
| Ethanol | 2.00 | 2.00 | 2.01 | 2.00 | |
| Glycol Ether DE | 3.00 | 2.00 | 2.00 | 2.00 | 3.74 |
| KP-140 | | 0.18 | | 0.14 | 0.14 |
| Deionized Water | 37.52 | 37.04 | 38.67 | 37.45 | 34.92 |
| Tegofoamex 1488 | 0.01 | 0.01 | 0.03 | 0.01 | 0.01 |
| Color, Neutralize: | | | | | |
| Deionized Water | 29.74 | 31.37 | 29.19 | 31.02 | 27.79 |
| Colorant RU | 0.27 | 0.35 | 0.30 | 0.15 | |
| 0.4% Methylene | | | | | 4.79 |
| Blue | | | | | |
| 14% Ammonia | 0.71 | 0.55 | 0.61 | 0.45 | 0.43 |
| subtotal | 73.45 | 73.70 | 73.02 | 73.38 | 71.99 |
| Totals | 100.05 | 100.15 | 99.58 | 99.80 | 100.00 |
| Physical Properties: | | | | | |
| Theoretical % Solids | 3.31 | 3.42 | 3.28 | 3.25 | 2.98 |
| SCC polymer/Carrier | 59.4/ | 59.4/ | 59.4/ | 59.4/ | 56.9/ |
| Ratio | 40.6 | 40.6 | 40.6 | 40.6 | 43.1 |
| Viscosity, cP | 17.5 | 14 | 15 | 14.5 | 11 |
| pH | 9.7 | 9.7 | 8.9 | 9.6 | 9.2 |

1. A coated floor comprising
(1) a flooring substrate, and
(2) a solid coating of a Releasable SCC Polymer Composition which (i) is adjacent to the substrate, (ii) can be triggered by heat and (iii) comprises a sidechain crystalline polymer (SCC polymer) which has an onset of melting temperature, T₀, which is higher than any temperature to which the substrate will be exposed during normal use and a peak melting temperature (Tp) which is less than any temperature which will damage the substrate, preferably a Tp of at most 120° C.

2. A coated floor according to claim 1 wherein the SCC polymer has one or more of the following characteristics
(a) the SCC polymer has a To of at least 10° C., or at least 15° C., or at least 27° C., or at least 35° C., or at least 40° C.,
(b) the SCC polymer has a Tp of at most 80° C., preferably at most 60° C., particularly at most 50° C.,
(c) the SCC polymer has a Tp and a T₀, measured in degrees centigrade, such that the value of (Tₚ−T₀) is less than Tₚ^{0.7}, preferably less than 25° C., preferably less than 20° C., particularly less than 15° C.,
(d) the SCC polymer has a weight average molecular weight of at most 100,000 Da, preferably at most 50,000 Da, particularly at most 20,000 Da, and in some applications less than 10,000 Da,
(e) the SCC polymer has been prepared by an emulsion polymerization process which produces particles having a size of 0.07 to 0.5 μm, particularly 0.1 to 0.25 μm,
(f) the SCC polymer comprises units derived from one or more n-alkyl acrylates or methacrylates in proportions by weight such that the average length of the n-alkyl groups is 16-20, for example 16-18, carbon atoms, the n-alkyl groups for example containing 8-22 carbon atoms, and the polymer for example containing 90 to 98%, e.g. 94 to 97%, by weight of the units derived from one or more n-alkyl acrylates.
(g) the SCC polymer comprises 90-98%, e.g. 94-97%, by weight of units derived from octadecyl acrylate and hexadecyl acrylate, the ratio of octadecyl acrylate to hexadecyl acrylate units being for example 16 to 2.
(h) the SCC polymer contains, for example in amount greater than 1%, for example 1-4%, e.g. 2-4%, or 1-3%, or 1-2%, units derived from (i) a comonomer containing a carboxylic group, e.g. methacrylic acid, and/or (ii) a comonomer containing a hydroxyl group, e.g. hydroxyethyl acrylate, hydroxyethyl methacrylate hydroxypropyl acrylate or hydroxypropyl methacrylate.
(i) the SCC polymer has a heat of fusion of at least 20 Joules/g

3. A coated floor according to claim 2 wherein the Releasable SCC Polymer Composition comprises a matrix polymer.

4. A coated floor according to claim 3 wherein the matrix polymer has one or more of the following characteristics:—
(a) the matrix polymer has a minimum film forming temperature (MFFT) which is at most 20° C.,
(b) the matrix polymer has a minimum film forming temperature (MFFT) which is at least 20° C.
(c) the matrix polymer is miscible with water,
(d) the matrix polymer is an acrylic or styrene-acrylic polymer prepared by emulsion polymerization, for example a cross-linked styrene-ethylhexylacrylate-methacrylic acid polymer, a styrene-butylacrylate-methacrylic acid polymer, a styrene-butylacrylate-methylmethacrylate-methacrylic acid polymer, or an isobutyl methacrylate-methylmethacrylate-hydroxyethyl acrylate,
(e) the matrix polymer is composed of particles which are smaller than the particles of the SCC polymer, and
(f) the matrix polymer forms a continuous phase in which the SCC polymer is dispersed in the form of particles.

5. A coated floor according to claim 4 wherein the solid coating of the Releasable SCC Polymer Composition comprises 30-80%, e.g. 40-70% or 50-60%, of the SCC polymer and 20-70%, for example 30-60% or 40-50%, of the matrix polymer.

6. A coated floor according to claim 5 wherein the Releasable SCC Polymer Composition has a thickness of less than 5 μm, preferably less than 2 μm, e.g. less than 1 μm.

7. A coated floor according to claim 4 wherein the Releasable SCC Polymer Composition directly contacts the flooring substrate, or is separated from the flooring substrate by an intermediate coating comprising a polymeric composition which does not include an SCC polymer.

8. A coated floor according to claim 7 wherein the flooring substrate is a vinyl composition tile.

9. A coated floor according to claim 4 which comprises an exterior coating on top of the solid coating of the Releasable SCC Polymer Composition, the exterior coating comprising one or more coatings of a commercially available flooring finish.

10. A liquid composition comprising (1) an SCC polymer which has an onset of melting temperature, T₀, of at least 27° C. and a peak melting temperature (Tp) of at most 120° C. and (2) a matrix polymer, wherein
(A) the SCC polymer has one or more of the following characteristics
(a) the SCC polymer has a To of at least 10° C., or at least 15° C., or at least 27° C., or at least 35° C., or at least 40° C.,
(b) the SCC polymer has a Tp of at most 80° C., preferably at most 60° C., particularly at most 50° C.,
(c) the SCC polymer has a Tp and a T₀, measured in degrees centigrade, such that the value of (Tₚ−T₀) is less than Tₚ^{0.7}, preferably less than 25° C., preferably less than 20° C., particularly less than 15° C.,
(d) the SCC polymer has a weight average molecular weight of at most 100,000 Da, preferably at most 50,000 Da, particularly at most 20,000 Da, and in some applications less than 10,000 Da,
(e) the SCC polymer has been prepared by an emulsion polymerization process which produces particles having a size of 0.07 to 0.5 μm, particularly 0.1 to 0.25 μm,
(f) the SCC polymer comprises units derived from one or more n-alkyl acrylates or methacrylates in proportions by weight such that the average length of the n-alkyl groups is 16-20, for example 16-18, carbon atoms, the n-alkyl groups for example containing 8-22 carbon atoms, and the polymer for example containing 90 to 98%, e.g. 94 to 97%, by weight of the units derived from one or more n-alkyl acrylates.
(g) the SCC polymer comprises 90-98%, e.g. 94-97%, by weight of units derived from octadecyl acrylate and hexadecyl acrylate, the ratio of octadecyl acrylate to hexadecyl acrylate units being for example 16 to 2.
(h) the SCC polymer contains, for example in amount greater than 1%, for example 1-4%, e.g. 2-4%, or 1-3%, or 1-2%, units derived from (i) a comonomer containing a carboxylic group, e.g. methacrylic acid, and/or (ii) a comonomer containing a hydroxyl group, e.g. hydroxyethyl acrylate, hydroxyethyl methacrylate hydroxypropyl acrylate or hydroxypropyl methacrylate, and
(i) the SCC polymer has a heat of fusion of at least 20 Joules/g; and
(B) the matrix polymer has one or more of the following characteristics:—
(a) the matrix polymer has a minimum film forming temperature (MFFT) which is at most 20° C.,
(b) the matrix polymer has a minimum film forming temperature (MFFT) which is at least 20° C.
(c) the matrix polymer is miscible with water,
(d) the matrix polymer is an acrylic or styrene-acrylic polymer prepared by emulsion polymerization, for example a cross-linked styrene-ethylhexylacrylate-methacrylic acid polymer, a styrene-butylacrylate-methacrylic acid polymer, a styrene-butylacrylate-methylmethacrylate-methacrylic acid polymer, or an isobutyl methacrylate-methylmethacrylate-hydroxyethyl acrylate polymer,
(e) the matrix polymer is composed of particles which are smaller than the particles of the SCC polymer, and
(f) the matrix polymer forms a continuous phase in which the SCC polymer is dispersed in the form of particles.
